(19) United States
(12) Patent Application Publication
(10) Pub. No.: US 2015/0343832 A1
(43) Pub. Date: Dec. 3, 2015

(54) MULTI PENCIL

(71) Applicant: TOKIWA CORPORATION, Nakatsugawa-shi (JP)

(72) Inventor: Yoshikazu Tani, Kawaguchi-shi (JP)

(73) Assignee: TOKIWA CORPORATION, Nakatsugawa-shi (JP)

(21) Appl. No.: 14/685,816

(22) Filed: Apr. 14, 2015

(30) Foreign Application Priority Data
Jun. 3, 2014 (JP) 2014-114690

(51) Int. Cl. B43K 24/16; B43K 27/04

(52) U.S. Cl. CPC B43K 24/163; B43K 27/04

(57) ABSTRACT

A multi pencil includes a cylindrical main body, a cylindrical leading tube engaged with the main body, and a plurality of sliding parts that are each coupled with a plurality of drawing materials held in the interior of the leading tube and slidably provided by a constant distance with respect to the main body. Regarding this configuration, one arbitrary sliding part, out of the plurality of sliding parts, moves forward by a constant distance with respect to the main body, whereby the drawing material coupled with the sliding part is exposed from the leading tube, and in this state, the leading tube and the main body are relatively rotated in one direction, which allows the drawing material to move forward. In the multi pencil, the forward movement of the drawing material is regulated by the relative rotation of the leading tube and the main body in the one direction.

### TECHNICAL FIELD

The present invention relates to a multi pencil used in a manner that one out of a plurality of drawing materials is thrust.

### BACKGROUND ART

As a conventional multi pencil, for example, there has been known a multi pencil disclosed in Japanese Unexamined Utility Model Application Publication No. 1993-39418 (Patent Literature 1). Patent Literature 1 discloses a cosmetic material feed container that includes a cylindrical main body inclusive of a plurality of longitudinal holes, and a tapered tube rotatably fitted to the frontal portion of the main body and formed in such a manner that the frontal portion contracts, as constitutional elements in its appearance. A plurality of thrust pieces that include a push button projected from the longitudinal hole of the main body, a plurality of screw tubes coupled with the frontal portion of each thrust piece, a plurality of coupling pipes rotatably coupled with the frontal portion of each screw tube, and a plurality of holding tubes provided in the frontal portion of each coupling pipe are provided in the interior of the cosmetic material feed container. A square-shaped insertion hole is provided in the tip end portion of the tapered tube, and the holding tube is formed in a square shape in such a manner as to be inserted into the insertion hole of the tapered tube. Also, a push rod that includes a projection is inserted into the interior of the screw tube and the coupling pipe, and the projection of the push rod is threadedly engaged with a screw in the screw tube. A core chuck in which a rod-shaped cosmetic material is mounted is coupled with the frontal portion of the push rod.

Regarding the cosmetic material feed container disclosed in the above-mentioned Patent Literature 1, when one thrust piece is moved forward along the longitudinal hole, the screw tube, the coupling pipe, the holding tube, the push rod, and the core chuck integrally move forward. Then, the holding tube advances along the inner surface of the tapered tube and is unrotatably inserted into the insertion hole in a state where the screw tube and the coupling pipe are bent. In this state, when the tapered tube is rotated in one direction with respect to the main body, the holding tube, the coupling pipe, and the push rod rotate with the tapered tube. Then, the push rod advances with respect to the screw tube, and the core chuck advances in response to the movement of the push rod, thereby thrusting the cosmetic material from the holding tube to the front.

### CITATION LIST

### Patent Literature

Patent Literature 1: Japanese Unexamined Utility Model Application Publication No. 1993-39418

### SUMMARY OF INVENTION

### Problems to be Solved by the Invention

Regarding the above-mentioned cosmetic material feed container, when the tapered tube is rotated with respect to the main body in the other direction, the push rod moves backward with respect to the screw tube. The core chuck coupled with the frontal portion of the push rod holds the drawing material such as a rod-shaped cosmetic material, so that the drawing material held by the core chuck is also returned backward in response to the backward movement of the push rod. Thus, it is configured such that the drawing material is moved backward in a state where the core chuck holds the drawing material, so that the drawing material needs to be constituted of a rigid material in some extent. Accordingly, there is a problem in that the drawing material formed of soft materials cannot be applied. Also, regarding the above-mentioned cosmetic material feed container, a situation is assumed in which the drawing material is moved backward more than necessary. In this case, the drawing material needs to be additionally moved forward in the next round of use, so that there is room for improvement in terms of usability.

Accordingly, in view of the aforementioned problems, it is an object of the present invention to provide a multi pencil in which a drawing material constituted of a soft material can be used, and usability can be improved.

### Solution to Problems

In order to solve the problem described above, the multi pencil according to an embodiment of the present invention may include a cylindrical main body, a cylindrical leading tube configured to be engaged with the main body, and a plurality of sliding parts configured to be each coupled with a plurality of drawing materials held in an interior of the leading tube and configured to be slidably provided by a constant distance with respect to the main body, wherein one arbitrary sliding part, out of the plurality of sliding parts, moves forward by a constant distance with respect to the main body, whereby the drawing material coupled with the one arbitrary sliding part is exposed from the leading tube, and in this state, the leading tube and the main body are relatively rotated in one direction, which allows the drawing material to move forward, and wherein only a forward movement of the drawing material is regulated by the relative rotation of the leading tube and the main body in the one direction.

In the multi pencil, the drawing material is coupled with each sliding part, and one arbitrary sliding part moves forward by a constant distance with respect to the main body, whereby the drawing material coupled with the one arbitrary sliding part is exposed from the leading tube. Then, in this state, the leading tube and the main body are relatively rotated in one direction, whereby the drawing material is configured to move forward, and furthermore, only the forward movement of the drawing material is regulated. Thus, it is configured that it only needs to consider the thrust of the drawing material to the front side by means of the relative rotation in the one direction. Accordingly, for example, this eliminates the constitution in which the drawing material is moved backward while being held, so that the drawing material, which is made of soft materials that are difficult to hold, can be applied to the multi pencil. Also, regarding the multi pencil of the present invention, the drawing material is not moved backward, so that there is no problem in that the drawing material needs to be additionally moved forward in the next round of use. Consequently, the usability can be improved.

As preferred constitution in which the above-mentioned actions and effects are provided, specifically, constitution is exemplified, wherein a ratchet mechanism is provided that allows the relative rotation of the leading tube and the main body in the one direction and regulates the relative rotation of the leading tube and the main body in other direction, which is opposite to the one direction.

Also, the multi pencil may include an inner tube positioned on the front side of the main body, and the ratchet mechanism includes protruding portions that protrude from an outer surface of the inner tube and have elasticity in a radial direction, and concave and convex portion that is provided on an inner surface of the leading tube and rotatably engaged with the protruding portions. In this case, the protruding portions that protrude from the outer surface of the inner tube and the concave and convex portion that is provided on the inner surface of the leading tube can be utilized as the ratchet mechanism.

Also, the protruding portions of the inner tube may be abutted with the concave and convex portion of the leading tube at all times. Thus, when the protruding portions that protrude from the outer surface of the inner tube and the concave and convex portion that is provided on the inner surface of the leading tube are closely disposed with each other at all times, resistance can be generated at all times between the outer surface of the inner tube and the inner surface of the leading tube, so that unsteadiness between the inner tube and the leading tube can be restrained.

Also, the multi pencil may include a pipe member configured to be positioned in an interior of the leading tube, the pipe member in which the drawing material is loaded, a movable body configured to extend in an axial direction on a rear side of the drawing material and configured to include a male screw having infinitesimal pitches on an outer circumference, and a screw tube configured to be synchronously rotatably engaged with a rear side of the pipe member and configured to include a female screw that is threadedly engaged with the male screw on an inner circumference, wherein the sliding part moves forward by a constant distance with respect to the main body, which allows the pipe member to move forward and engage the leading tube in a rotational direction, and wherein, in this state, the leading tube and the main body are relatively rotated in the one direction, whereby the movable body moves forward with the drawing material by action of a screw-threaded engagement between the male screw and the female screw. In this case, the male screws formed on the outer circumference of the movable body have infinitesimal pitches, so that the shifting amount of the movable body by means of the relative rotation in one direction is also infinitesimal. Accordingly, the fine adjustment of the drawing material that is thrust forward can be made, and the malfunction that the drawing material thrust out is snapped can be prevented, so that the usability can further be improved.

Also, it may be such that a front end of the movable body is formed in a cylindrical shape having a flat bottom surface, and the bottom surface thrusts the drawing material forward, which allows the drawing material to move forward. In this case, this eliminates the core chuck that holds the drawing material, so that the drawing material is configured to be thrust out by the bottom surface of the front end of the cylindrical movable body.

Also, the multi pencil may include a holding member configured to be arranged on a rear side of the screw tube and hold the movable body inside, wherein a cross section of the movable body is formed in a non-circular shape, and wherein the holding member includes a hole part formed in a non-circular shape in accordance with a cross-sectional shape of the movable body. In this case, the movable body, whose cross section is formed in a non-circular shape, is inserted into the hole part formed in a non-circular shape, which allows the engagement of the movable body with the holding member in the rotational direction, so that the holding member can function as a rotational stop for the movable body.

Also, the holding member may include an elastic portion configured to provide the movable body inserted in the hole part with an elastic force from an outer side. In this case, the movable body in the hole part can be held by the elastic force of the elastic portion from the outer side, so that the movable body can be mounted on the holding member by the application of the elastic force, and the movable body can be detached from the holding member by releasing the elastic force, and the movable body can be mounted on and detached from the holding member in an easy manner.

### Advantageous Effects of Invention

According to an embodiment of the present invention, a drawing material constituted of a soft material can be used, and usability can be improved.

### BRIEF DESCRIPTION OF DRAWINGS

FIG. 1 is a side view illustrating a multi pencil according to the present embodiment;

FIG. 2 is a perspective view illustrating a state where a leading tube and a cartridge are detached from the multi pencil of FIG. 1;

FIG. 3 is a cross-sectional perspective view illustrating the multi pencil of FIG. 1;

FIG. 4 is a cross-sectional perspective view illustrating a state where a sliding part is moved forward in the multi pencil of FIG. 1;

FIG. 5 is a perspective view illustrating each component arranged on the inner side of the multi pencil of FIG. 1;

FIG. 6 is a perspective view illustrating each component constituting the outer appearance of the multi pencil of FIG. 1;

FIG. 7 is a cross-sectional perspective view of the leading tube;

FIG. 8A is a perspective view of an inner tube. FIG. 8B is a cross-sectional perspective view of the inner tube;

FIG. 9 is a cross-sectional view taken along a line A-A of FIG. 1;

FIG. 10 is a partially cross-sectional perspective view of a holding member and a perspective view of an O-ring;

FIG. 11 is a perspective view of a movable body;

FIG. 12 is a cross-sectional perspective view of a screw tube;

FIG. 13 is a perspective view of a pipe member and a drawing material;

FIG. 14 is a perspective view of the sliding part; and

FIG. 15A is a perspective view of the main body. FIG. 15B is a cross-sectional perspective view of the main body.

### DESCRIPTION OF EMBODIMENTS

Hereinafter, the embodiments of the present invention will be described referring to drawings. It is noted that the same or corresponding elements are designated as the same references in the description below, and duplicated descriptions are omitted.

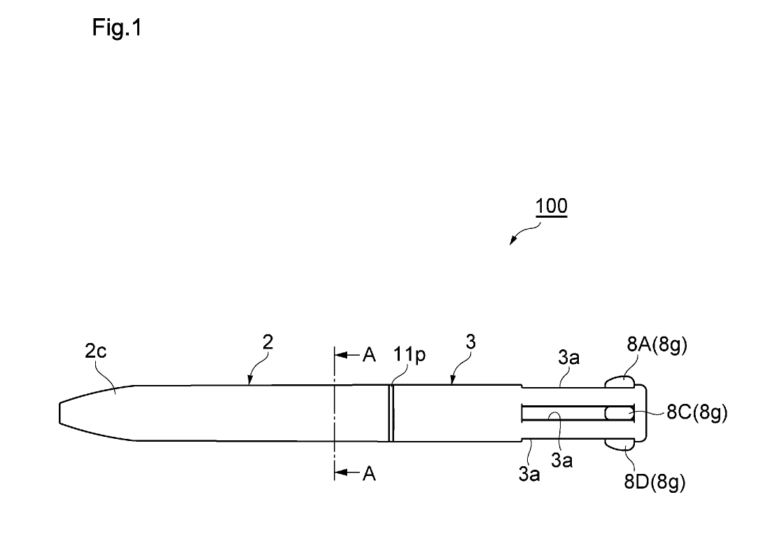

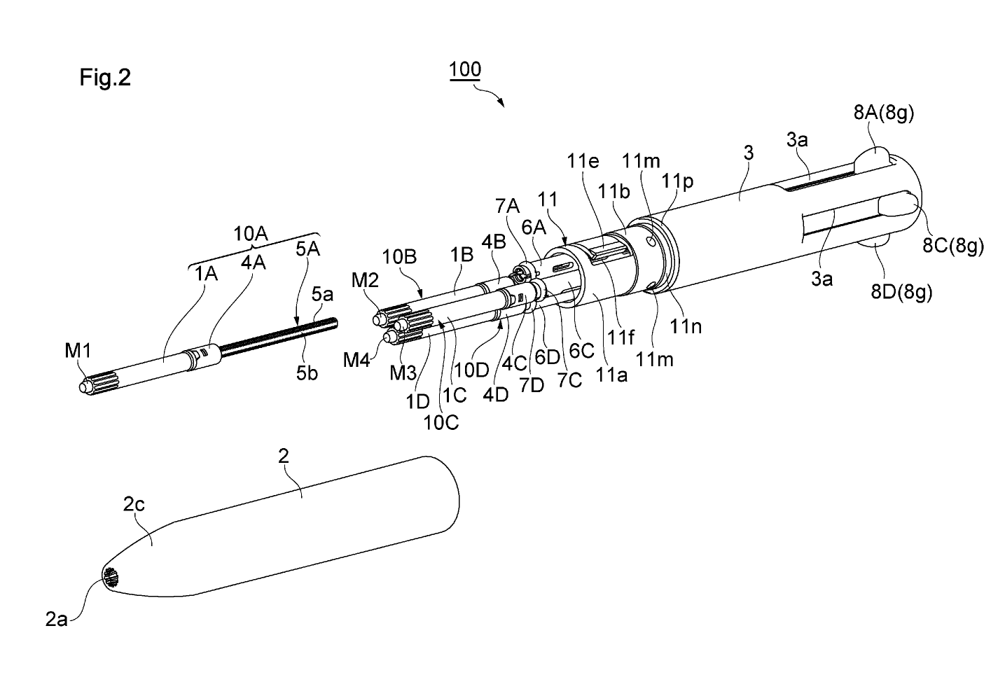

FIG. 1 is a side view illustrating the outer appearance of a multi pencil according to the present embodiment. FIG. 2 is a perspective view illustrating a state where a leading tube and a cartridge are detached from the multi pencil of FIG. 1. As illustrated in FIGS. 1 and 2, regarding a multi pencil 100 of the present embodiment, any of a plurality of drawing materials M1 to M4 loaded in the respective interiors of four pipe members 1A to 1D is appropriately discharged (thrust out) through the operation of a user. In the present embodiment, the drawing materials M1 to M4 represent drawing materials each having a different color.

For example, rod-shaped cores such as various rod-shaped cosmetic materials or writing materials, which are exemplified by lip sticks, lip glosses, eyeliners, eyebrows, lip liners, cheek rouges, concealers, cosmetic sticks, and sticks used for hair coloring or nail art, can be applied for the drawing materials M1 to M4. Furthermore, it is preferable that a very soft rod-shaped member (a semisolid, soft-solid, soft, gelatinous, or mousse-like rod-shaped member, or a pasty member inclusive of the above-mentioned states) be used. Also, a small-diameter rod-shaped member whose outer diameter is equal to or less than 1.0 mm, a general rod-shaped member whose outer diameter ranges from 1.5 to 3.0 mm, and a thick rod-shaped member whose outer diameter is equal to or higher than 4.0 mm can be used.

The multi pencil 100 includes a leading tube 2 that includes the pipe members 1A to 1D inside, to which the drawing materials M1 to M4 are loaded, and a main body 3 that is coupled with the rear end portion of the leading tube 2 and relatively rotatably engaged with the leading tube 2, as constitutional elements in its appearance. In the description below, “axial line” represents the center line of the multi pencil 100, which extends in the back and front of the multi pencil 100, and “axial direction” represents the back-and-forth direction along with the axial line. Also, a direction that the drawing materials M1 to M4 are fed is represented as a forward direction (advancing direction), and a direction opposite to the forward direction is represented as a rearward direction.

A screw tube 4A is synchronously rotatably engaged with the rear portion of the pipe member 1A, and a rod-shaped movable body 5A that includes a male screw 5a is threadedly engaged with the interior of the screw tube 4A. A cartridge 10A that is exchangeable with respect to the main body 3 is constituted by the pipe member 1A, the screw tube 4A, and the movable body 5A. The constitution of the pipe members 1B to 1D is the same as that of the pipe member 1A, and respective cartridges 10B to 10D are constituted by the pipe members 1B to 1D, screw tubes 4B to 4D, movable bodies 5B to 5D.

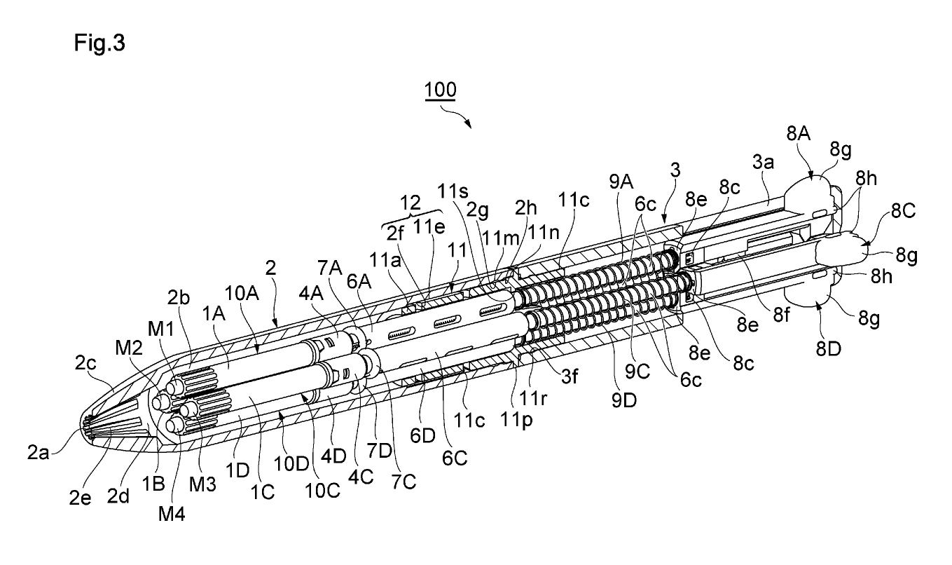

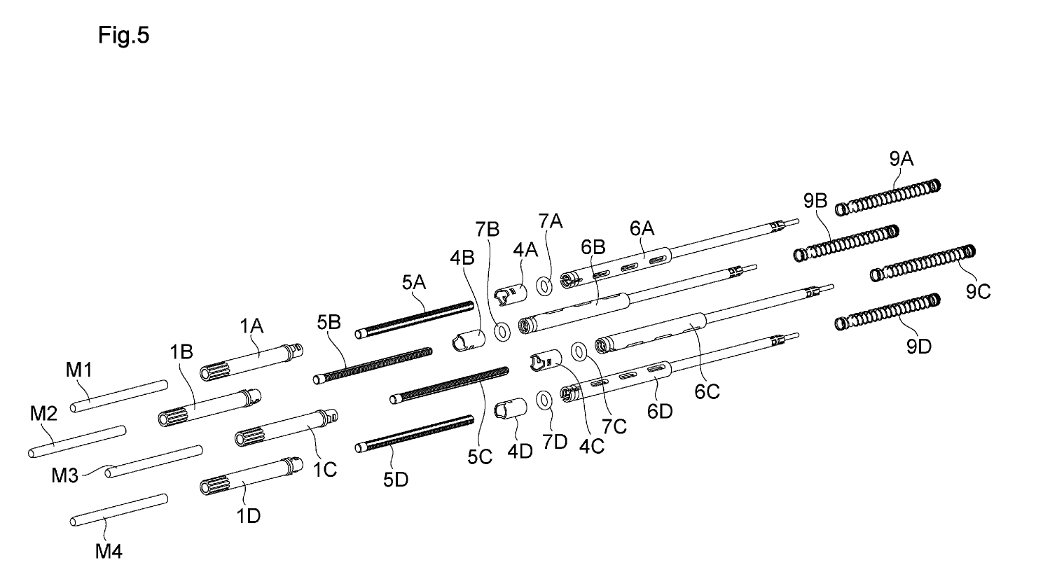

As described in FIGS. 2 to 4, a cylindrical holding member 6A that holds the movable body 5A, an O-ring (elastic portion) 7A that provides the holding member 6A with an elastic force from the outer side, a sliding part 8A that is synchronously rotatably engaged with the holding member 6A at the rear portion of the holding member 6A, and a spring 9A that energizes the sliding part 8A backward are provided in the rear portion of the cartridge 10A. Also, as illustrated in FIGS. 3 to 5, holding members 6B to 6D, O-rings 7B to 7D, sliding parts 8B to 8D, and springs 9B to 9D are provided in the respective rear portions of the cartridges 10B to 10D, as is the same with the cartridge 10A.

As described above, the pipe members 1A to 1D in which the drawing materials M1 to M4 are loaded, the movable bodies 5A to 5D, the screw tubes 4A to 4D, the O-rings 7A to 7D, the holding members 6A to 6D, the springs 9A to 9D, and the sliding parts 8A to 8D are provided in the interior of the leading tube 2 and the main body 3. Respective constitutions are the same, regarding the pipe members 1A to 1D, the movable bodies 5A to 5D, the screw tubes 4A to 4D, the O-rings 7A to 7D, the holding members 6A to 6D, the springs 9A to 9D, and the sliding parts 8A to 8D, except that any one of the drawing materials M1 to M4, each of which has a different color, is loaded.

Accordingly, in the description below, the pipe members 1A to 1D, the movable bodies 5A to 5D, the screw tubes 4A to 4D, the O-rings 7A to 7D, the holding members 6A to 6D, the springs 9A to 9D, and the sliding parts 8A to 8D are merely referred to respectively as the pipe member 1, the movable body 5, the screw tube 4, the O-ring 7, the holding member 6, the spring 9, and the sliding part 8. Also, the cartridges 10A to 10D and the drawing materials M1 to M4 are merely referred to respectively as the cartridge 10 and the drawing material M.

As illustrated in FIGS. 3, 4 and 6, an inner tube 11 is synchronously rotatably engaged with the front end of the main body 3, and four holding members 6 are held in the interior of the inner tube 11. Also, a ratchet mechanism 12, which allows the relative rotation of the leading tube 2 and the main body 3 (inner tube 11) only in one direction, is provided in the inner tube 11 and the leading tube 2. The relative rotation of the leading tube 2 and the main body 3 in the other direction, which is opposite to the one direction, is regulated by the ratchet mechanism 12.

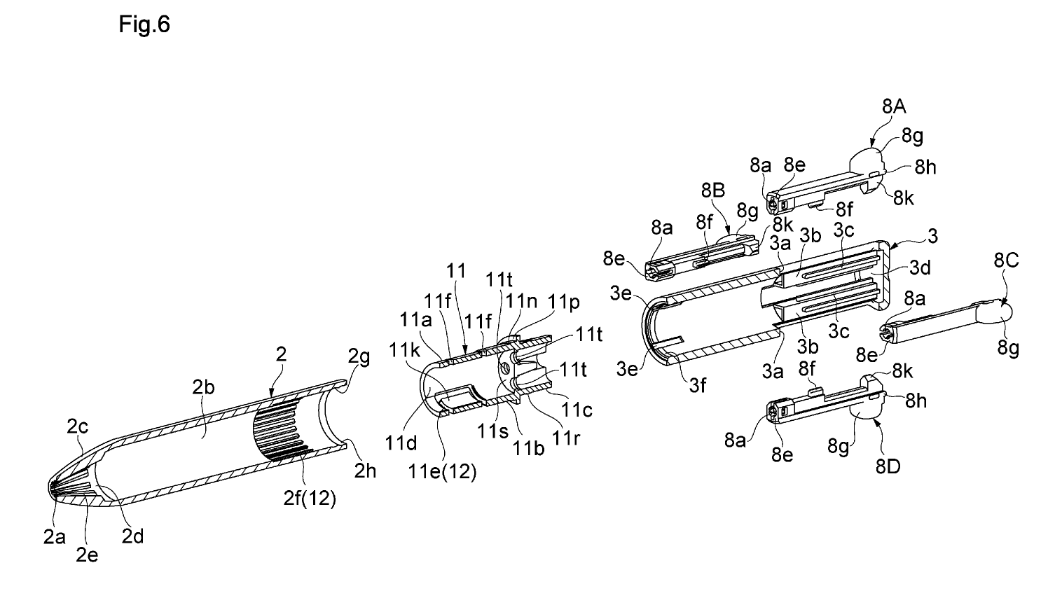

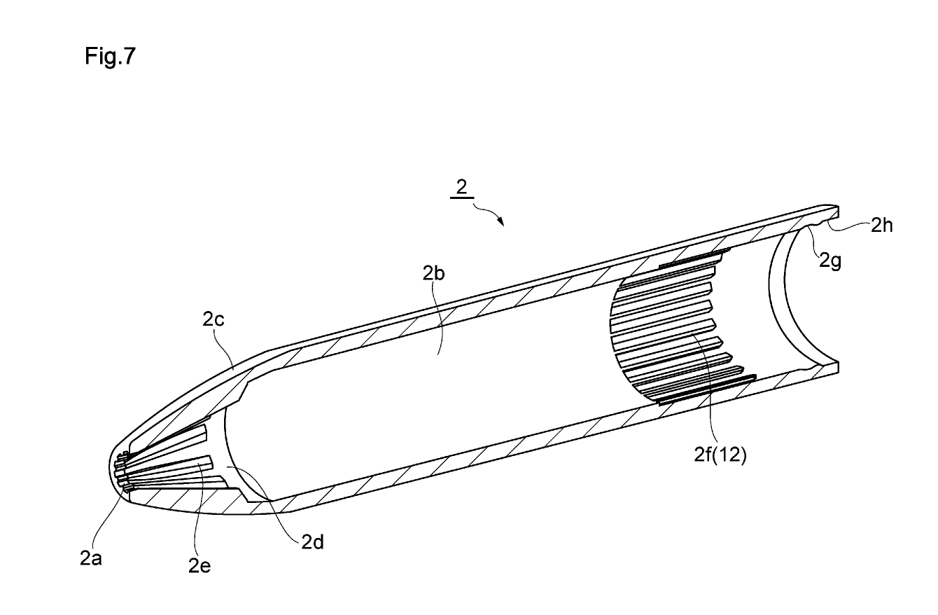

FIG. 7 is an enlarged, cross-sectional perspective view of the leading tube 2 of FIG. 6. As illustrated in FIG. 7, the leading tube 2 is formed of acrylonitrile butadiene styrene copolymerized synthetic resin (ABS resin) in a cylindrical shape and includes an opening portion 2a that allows the front-side portion of the pipe member 1 to emerge at the tip end. A storage area 2b that stores the four cartridges 10 and the four holding members 6 is provided in the interior of the leading tube 2, and any of the four pipe members 1 provided in the storage area 2b is exposed forward from the opening portion 2a in accordance with the operation of the user.

An inclined surface 2c, which inclines in such a manner as to taper off as it goes to the front, is provided on the front side on the outer circumferential surface of the leading tube 2. The inner circumferential surface 2d of the leading tube 2 on the front side also tapers off as it goes to the front side. A multitude of convex portions are disposed in parallel on the inner circumferential surface 2d in the circumferential direction, as sections engaged with the pipe member 1 in the rotational direction (direction around the axial line), and protrusions 2e formed by the convex portions extended by a predetermined length in the inclined direction of the inner circumferential surface 2d are provided. The intervals between the protruding portions of the protrusions 2e narrow as the protrusions 2e advance to the front side.

On the rear portion side on the inner circumferential surface of the leading tube 2, concave and convex portion 2f that constitutes one of the ratchet mechanism 12 is provided. 24 projections and depressions are disposed in parallel in the circumferential direction of the concave and convex portion 2f, and each of the projection extends in the axial direction. Also, annular concave portions 2g and 2h engaged with the inner tube 11 in the rear portion of the leading tube 2 in the axial direction are provided on the rear side of the concave and convex portion 2f on the inner circumferential surface of the leading tube 2.

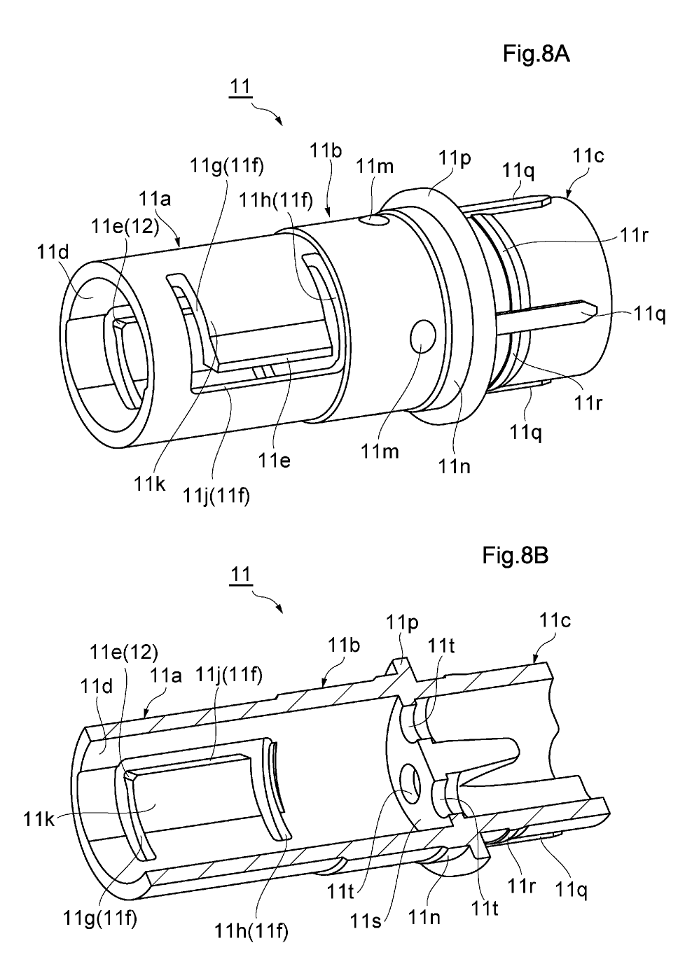

FIG. 8A is an enlarged perspective view of the inner tube 11 of FIG. 6. FIG. 8B is an enlarged cross-sectional perspective view of the inner tube 11 of FIG. 6. The inner tube 11 is formed of polyacetal (POM) by means of injection molding and has an annular shape with steps in its appearance. The inner tube 11 includes a front end cylindrical portion 11a, a central cylindrical portion 11b whose diameter is larger than the diameter of the front end cylindrical portion 11a, and a rear end cylindrical portion 11c whose diameter is smaller than those of the front end cylindrical portion 11a and the central cylindrical portion 11b, in the order of the above-mentioned description from the front to the rear.

The front end cylindrical portion 11a includes protruding portions 11e that constitute the other of the ratchet mechanism 12 at a pair of positions facing with each other on the inner circumferential surface 11d thereof. The protruding portions 11e are engaged with the concave and convex portion 2f of the leading tube 2 in the rotational direction and provided in such a manner as to protrude on the outer side in the radial direction. C-shaped notches 11f communicated with the inside and outside of the inner tube 11 are formed in the periphery of the protruding portions 11e of the front end cylindrical portion 11a, and the notches 11f provide the protruding portions 11e with elasticity in the radial direction. The protruding portions 11e of the inner tube 11 are brought into close contact with the concave and convex portion 2f of the leading tube 2 at all times.

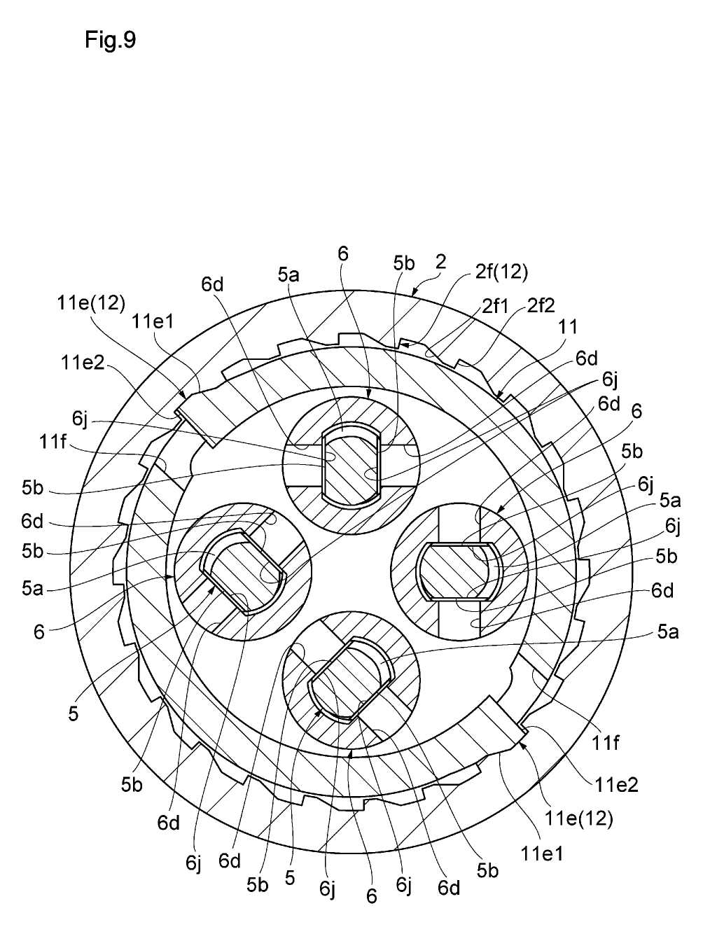

FIG. 9 is a cross-sectional view taken along a line A-A of FIG. 1. As described in FIG. 9, the concave and convex portion 2f of the leading tube 2, which constitutes the one of the ratchet mechanism 12, includes inclined surfaces 2f1 and lateral surfaces 2f2. The inclined surfaces 2f1 incline with respect to the inner circumferential surface of the leading tube 2. The lateral surfaces 2f2 are formed in such a manner to be disposed approximately perpendicular to the inner circumferential surface of the leading tube 2. Also, the protruding portions 11e of the inner tube 11, which constitute the other of the ratchet mechanism 12, include inclined surfaces 11e1 and lateral surfaces 11e2. The inclined surface 11e1 inclines with respect to the outer circumferential surface of the inner tube 11. The lateral surfaces 11e2 is formed in such a manner to be disposed approximately perpendicular to the tangent of the outer circumferential surface of the inner tube 11.

As illustrated in FIG. 8, the notches 11f of the inner tube 11 include a pair of slits 11g and 11h that are drilled on bilateral sides of the protruding portions 11e of the front end cylindrical portion 11a in the axial direction and extended in the circumferential direction, and slits 11j that are drilled on one side of the protruding portions 11e of the front end cylindrical portion 11a in the circumferential direction and continuously extended in the axial direction with respect to the slits 11g and 11h. A wall portion surrounded by the notches 11f in the front end cylindrical portion 11a forms an arm 11k having flexibility in the radial direction. Accordingly, the protruding portions 11e disposed on the outer surface at the tip end portion of the arm 11k have elasticity (energized force) in the radial direction.

Protrusions 11m engaged with the annular concave portions 2g of the leading tube 2 and an annular convex portion 11n that is inserted into the annular concave portion 2h of the leading tube 2 from the rear are provided on the outer circumferential surface of the central cylindrical portion 11b of the inner tube 11. An annular collar portion 11p is provided in the rear portion of the annular convex portion 11n on the outer circumferential surface of the central cylindrical portion 11b, and the cylindrical portion on the front side with respect to the collar portion 11p serves as an insertion portion, which is inserted into the leading tube 2 from the rear.

Protrusions 11q engaged with the main body 3 in the rotational direction are formed on the rear end cylindrical portion 11c of the inner tube 11 in such a manner as to extend in the axial direction. The protrusions 11q are formed at positions equally divided by four in the circumferential direction on the outer circumferential surface of the rear end cylindrical portion 11c. Also, a convex portion 11r engaged with the main body 3 in the axial direction is formed on the rear side of the collar portion 11p, and the convex portion 11r extends in the circumferential direction between the protrusions 11q.

The inner tube 11 is partitioned into the left and right on the drawing by means of a holding member storage portion 11s, which is a disc-shaped portion that allows the four holding members 6 to penetrate in the axial direction, on the inner side of the collar portion 11p. Circular openings 11t, which allow the holding members 6 to penetrate in the axial direction, are provided in the holding member storage portion 11s at positions equally divided by four in the circumferential direction.

Regarding the inner tube 11, the front end cylindrical portion 11a and the central cylindrical portion 11b are inserted into the leading tube 2 from the rear side of the leading tube 2. In this time, the protruding portions 11e of the front end cylindrical portion 11a are engaged with the concave and convex portion 2f of the leading tube 2 in the rotational direction, and the protrusions 11m of the central cylindrical portion 11b are engaged with the annular concave portions 2g of the leading tube 2, and the annular convex portion 11n of the central cylindrical portion 11b is inserted into the annular concave portion 2h of the leading tube 2.

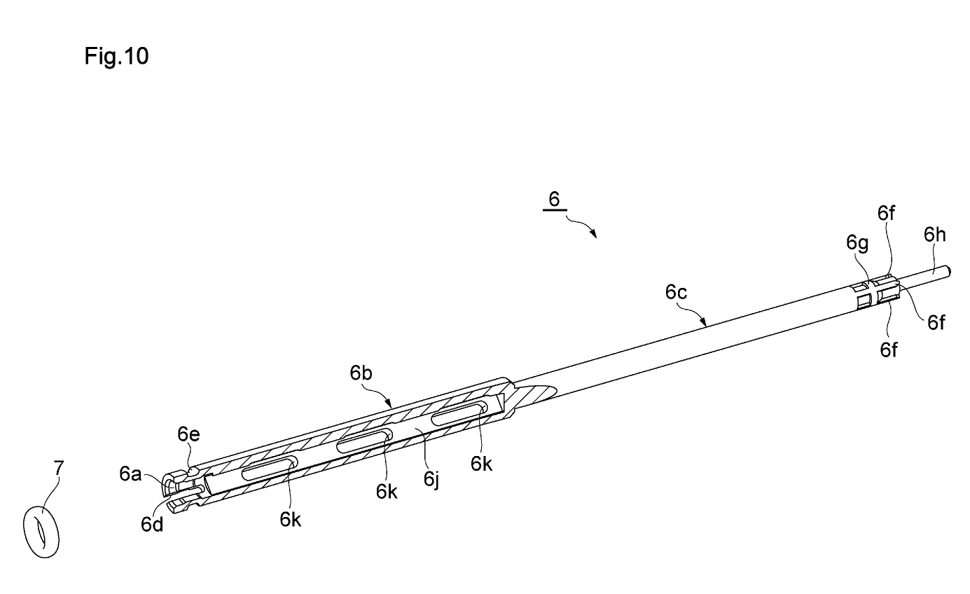

FIG. 10 is a partially cross-sectional perspective view illustrating the O-ring 7 and the holding member 6. The whole of the holding member 6 is formed in a rod shape in its appearance. For example, the POM is used as the material of the holding member 6. The holding member 6 includes an annular movable body holding portion 6b that includes a hole part 6a that is provided on the front side and stores the movable body 5, and a round-rod-shaped rod portion 6c extended in the axial direction in the rear portion of the movable body holding portion 6b.

The movable body holding portion 6b of the holding member 6 includes a pair of slits 6d that are extended by a predetermined length from the front end to the rear and formed in such a manner as to face with each other on the inner circumferential surface of the movable body holding portion 6b. The diameter of the front end of the movable body holding portion 6b can be expanded on the outer side in the radial direction by means of the slits 6d. An annular concave portion 6e into which the O-ring 7 is inserted is provided on the outer circumferential surface of a section in which the slits 6d of the movable body holding portion 6b are provided. The O-ring 7 is inserted into the annular concave portion 6e, whereby the movable body 5 held by the movable body holding portion 6b is tightened inward, which prevents the movable body 5 from coming off from the movable body holding portion 6b.

Plane portions 6j that synchronously rotate the movable body 5 are provided at a pair of positions facing with each other on the inner side of the movable body holding portion 6b of the holding member 6. When the movable body holding portion 6b is cut by the plane orthogonal to the axial direction, the cross section of the hole part 6a is formed in a non-circular shape by the plane portions 6j. Also, three oblong through holes 6k extended in the axial direction are provided in the plane portions 6j, in such a manner as to penetrate the holding member 6, in order to prevent a core pin from being inclined by the injection pressure at the time of molding and support the core pin. The rod portion 6c disposed in the rear of the movable body holding portion 6b, as constituted in the above-mentioned manner, is inserted into the opening 11t of the holding member storage portion 11s of the inner tube 11 in the axial direction.

Protrusions 6f engaged with the sliding parts 8 in the rotational direction are formed on the rear side of the rod portion 6c of the holding member 6 in such a manner as to extend in the axial direction, and the protrusions 6f are formed at positions equally divided by four in the circumferential direction on the outer circumferential surface of the rod portion 6c. Also, a convex portion 6g engaged with the sliding part 8 in the axial direction is formed on the rear side of the rod portion 6c, and the convex portion 6g extends in the circumferential direction between the protrusions 6f. Also, a rod-shaped projection 6h, which further protrudes backward in a state where its diameter is reduced from a section on which the protrusions 6f are provided, is provided on the rear end of the rod portion 6c. The projection 6h is used as a tool that facilitates ease of assembly on the sliding part 8 along with the spring 9.

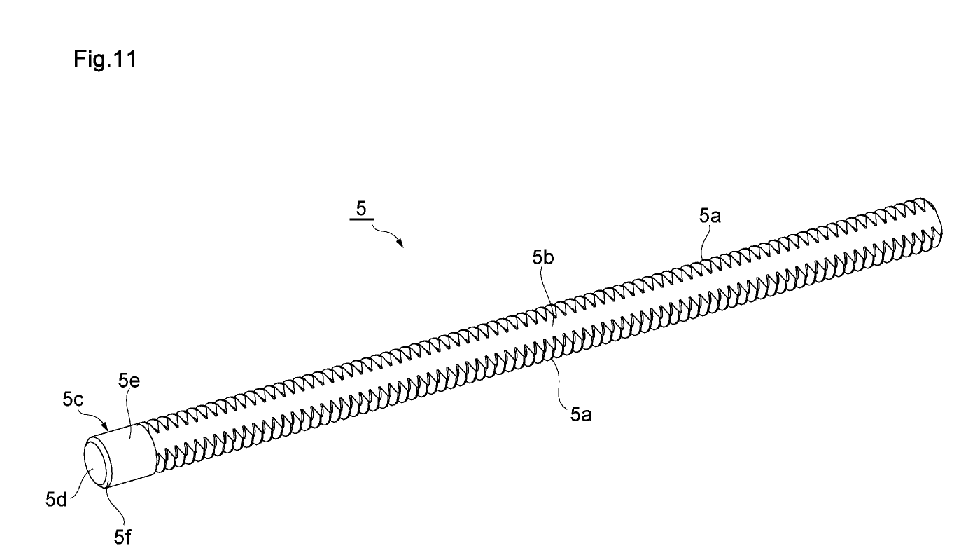

FIG. 11 is a perspective view of the movable body 5. The movable body 5 is formed in a rod shape in its appearance. For example, the POM is used as the material of the movable body 5. The movable body 5 includes male screws 5a and plane portions 5b that are pressed by the plane portions 6j of the holding member 6 (see FIG. 9) on the outer circumferential surface thereof. Regarding the plane portions 5b, when the male screws 5a and the plane portions 5b are cut by the plane orthogonal to the axial direction, their shapes are formed in a non-circular shape in accordance with the hole part 6a of the holding member 6.

The pitches of the male screws 5a of the movable body 5 (distances between the screw threads of the male screws 5a in the axial direction) are equal to or higher than 0.3 mm and equal to or lower than 1.0 mm, and are preferably equal to 0.4 mm. Conventionally, the pitches of the male screws are generally equal to or higher than 2.0 mm and equal to or lower than 6.0 mm. Accordingly, the pitches of the male screws 5a are infinitesimal pitches that are shorter than the pitches of the general male screws.

The plane portions 5b of the movable body 5 are provided in such a manner as to be extended in the axial direction in the section in which the male screws 5a are provided, and the plane portions 5b are provided at a pair of positions facing with each other on the outer circumferential surface of the movable body 5. The male screws 5a and the plane portions 5b of the movable body 5 are inserted into the movable body holding portion 6b from the front, with a clearance left between the plane portions 5b and the plane portions 6j of the movable body holding portion 6b. Then, the protrusions provided on the inner side of the movable body holding portion 6b and the male screws 5a of the movable body 5 are fitted, whereby the movable body 5 is held with respect to the movable body holding portion 6b. Also, an annular extruding portion 5c that extrudes the drawing material M forward in the pipe member 1 is provided at the front end of the movable body 5. The extruding portion 5c includes a flat bottom surface 5d positioned at the front end thereof, a lateral surface 5e extended in the circumferential direction, and a tapered surface 5f that inclines with respect to the bottom surface 5d and is continuously abutted with the bottom surface 5d and the lateral surface 5e. The flat bottom surface 5d of the extruding portion 5c is a surface that extrudes the drawing material M forward.

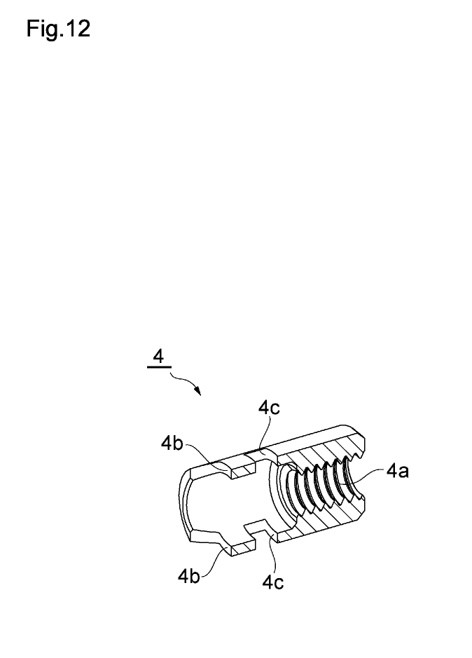

FIG. 12 is a cross-sectional perspective view of the screw tube 4. The screw tube 4 is formed in an approximately cylindrical shape. For example, the POM is used as the material of the screw tube 4. Female screws 4a that allow the movable body 5 to transfer are formed on the rear side on the inner circumferential surface of the screw tube 4. As is the same with the male screws 5a of the movable body 5, the pitches of the female screws 4a of the screw tube 4 (distances between the screw threads of the female screws 4a in the axial direction) are infinitesimal pitches that are shorter than the pitches of the general female screws. Also, concave portions 4b engaged with the rear end of the pipe member 1 at the front end of the screw tube 4 are provided on the front side of the screw tube 4, and the concave portions 4b are formed in a trapezoidal shape in which the front end of the screw tube 4 is notched by a predetermined length backward. The concave portions 4b are provided at a pair of positions facing with each other on the inner circumferential surface of the screw tube 4.

Hole parts 4c engaged with the rear end of the pipe member 1 are provided in the rear of the concave portions 4b of the screw tube 4, and the hole parts 4c are provided in such a manner as to penetrate the screw tube 4. The hole parts 4c are formed in a shape extended in the circumferential direction and provided at a pair of positions facing with each other on the inner circumferential surface of the screw tube 4.

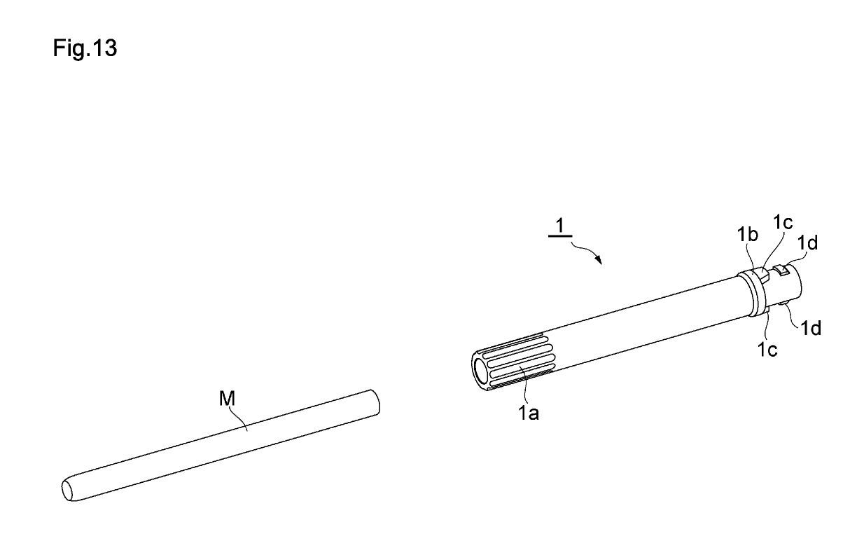

FIG. 13 is a perspective view of the pipe member 1 and the drawing material M. The pipe member 1 is formed in an approximately cylindrical shape. For example, polypropylene (PP) is used as the material of the pipe member 1. The pipe member 1 may be colored with the same color as that of the drawing material M or formed of transparent materials, which makes it possible to discriminate the color of the drawing material M in an easy manner. The inner surface (the area on which the drawing material M is loaded) of the pipe member 1 is formed in a flat shape having no step, so that the drawing material M can be easily loaded by suction over the whole of the inner surface of the pipe member 1. A multitude of concave portions are disposed in parallel at the front end portion on the outer circumferential surface of the pipe member 1 in the circumferential direction, as portions engaged with the protrusions 2e of the leading tube 2 in the rotational direction, and oblong concave grooves 1a formed by the concave portions extended by a predetermined length in the axial direction are provided.

An annular collar portion 1b, projections 1c engaged with the concave portion 4b of the screw tube 4 in the rear portion of the collar portion 1b, and protrusions 1d fitted into the hole part 4c of the screw tube 4 in the rear of the projections 1c are provided on the rear side on the outer circumferential surface of the pipe member 1. Accordingly, this allows the pipe member 1 and the screw tube 4 to engage each other in the axial direction and rotate in synchronism with each other. The height of the collar portion 1b with respect to the outer circumferential surface of the pipe member 1, the height of the projections 1c with respect to the outer circumferential surface of the pipe member 1, and the height of the screw tube 4 engaged with respect to the outer circumferential surface are approximately the same.

The projections 1c of the pipe member 1 are formed in a trapezoidal shape extended from the collar portion 1b of the pipe member 1 by a predetermined length backward. The projections 1c are provided at a pair of positions facing with each other on the outer circumferential surface of the pipe member 1. The protrusions 1d of the pipe member 1 are formed in a shape extended in the circumferential direction and provided at a pair of positions facing with each other on the outer circumferential surface of the pipe member 1. The pipe member 1 constituted in the above-mentioned manner is engaged with the screw tube 4 from the rear. In this time, the projections 1c of the pipe member 1 are fitted into the concave portion 4b of the screw tube 4, and the protrusions 1d of the pipe member 1 are fitted with the hole part 4c of the screw tube 4 from the inner side of the screw tube 4.

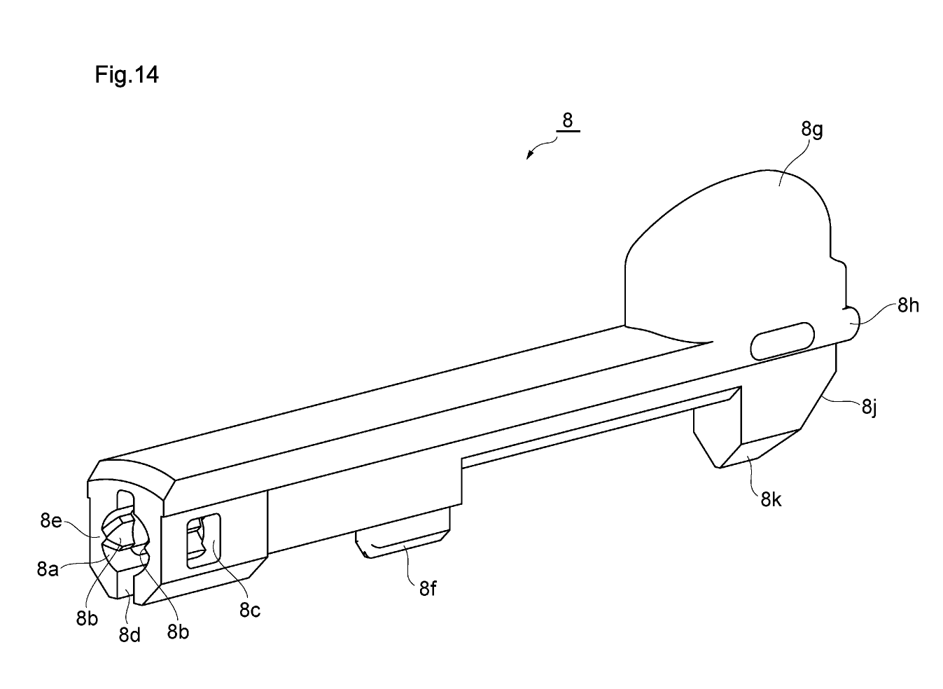

FIG. 14 is a perspective view of the sliding part 8. For example, acrylonitrile butadiene styrene (ABS) resin is used as the material of the sliding part 8. The color of the sliding part 8, for example, is the same color as that of the corresponding drawing material M. The sliding part 8 of a desired color is slid forward by a given distance, which makes it possible to expose the drawing material M of a desired color from the opening portion 2a of the leading tube 2 to the front.

The sliding part 8 is formed in a shape extended in the axial direction. A hole part 8a in which the projection 6h of the holding member 6 is inserted from the front is provided on the front side of the sliding part 8. Projections 8b and window portions 8c, which are engaged with the convex portion 6g of the holding member 6 in the axial direction and engaged with the protrusions 6f of the holding member 6 in the rotational direction, are provided in the hole part 8a. A notch 8d extended in the axial direction is provided in the hole part 8a in such a manner as to communicate. Also, a flat surface 8e abutted with one end of the spring 9 is provided at the front end of the sliding part 8.

A projection 8f that returns another sliding part 8 to the rear is provided in the rear of the window portion 8c of the sliding part 8, and the projection 8f protrudes on the inner side of the main body 3 and extends in the axial direction. A projection 8g that protrudes on the outer side of the main body 3, a rear end portion 8h that protrudes at the rear end of the sliding part 8 backward and is hooked on the main body 3, and a projection 8k that includes an inclined surface 8j that protrudes on the inner side of the main body 3 and is abutted with the projection 8f of another sliding part 8 are provided at the rear end of the sliding part 8.

The sliding part 8 constituted in the above-mentioned manner is engaged with the holding member 6 from the front thereof. In this time, the projection 6h of the holding member 6 is inserted in the hole part 8a of the sliding part 8, and the convex portion 6g of the holding member 6 climbs over the projection 8b of the sliding part 8, and the protrusions 6f and the convex portion 6g are engaged with the projection 8b and the window portions 8c, whereby the holding member 6 is synchronously rotatably engaged with the front side of the sliding part 8.

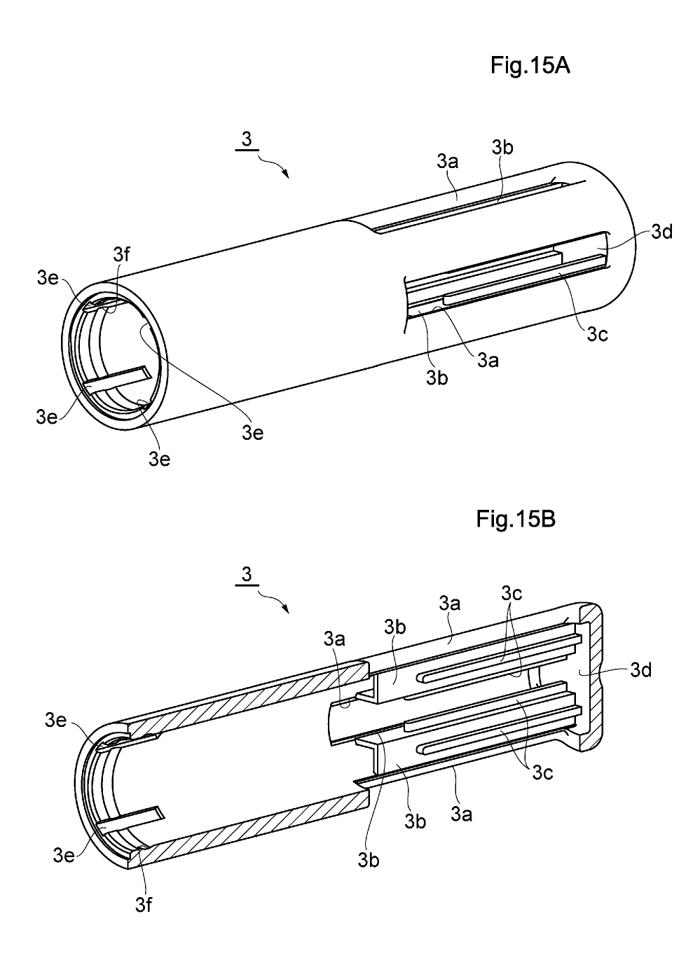

FIG. 15A is a perspective view of the main body 3. FIG. 15B is a cross-sectional perspective view of the main body 3. The main body 3 is formed of the ABS resin by means of injection molding and has a bottomed cylindrical shape. Notch portions 3a that extend in the axial direction and allow the projection 8g of the sliding part 8 to protrude outward are provided on the rear side of the main body 3, and the notch portions 3a are provided at positions equally divided by four in the circumferential direction.

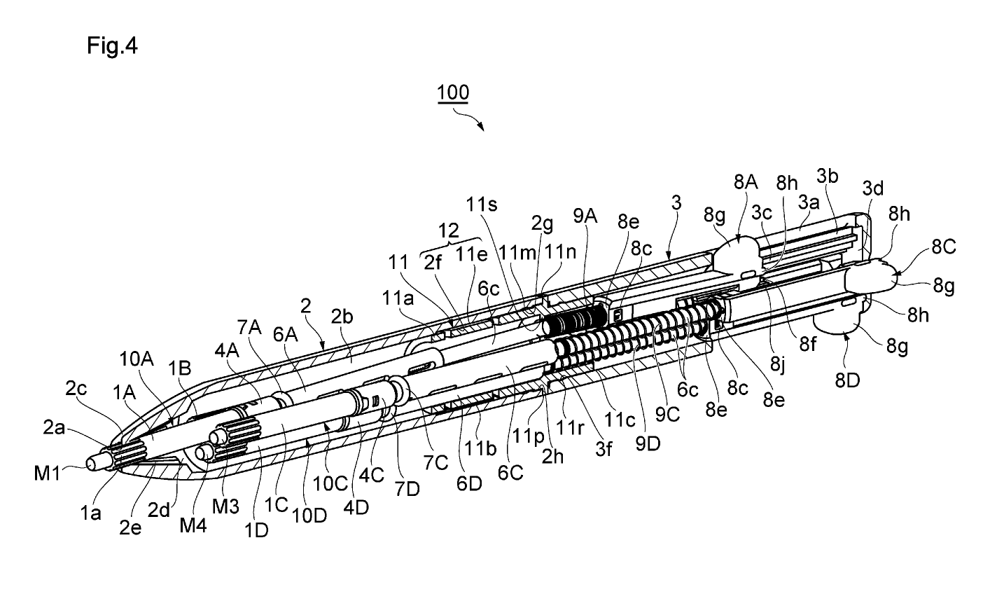

Flat portions 3b extended on the inner side from the notch portions 3a and projections 3c extended in the axial direction on the rear side of the flat portions 3b are provided on the inner side of the notch portions 3a of the main body 3. The rear side of the projections 3c extends to the bottom surface 3d of the main body 3. When the projection 8g of the sliding part 8 is moved forward along with the notch portions 3a of the main body 3, the rear end portion 8h of the sliding part 8 advances along with the projections 3c. When the rear end portion 8h reaches the front end of the projections 3c, the sliding part 8 enters the inner side of the notch portions 3a, and the rear end portion 8h is hooked at the front end of the projections 3c. Also, in a state where the rear end portion 8h of one sliding part 8 (for example, the sliding part 8A in FIG. 4) is hooked on the front end of the projections 3c, the inclined surface 8j of one sliding part 8 is disposed close to the projection 8f of another sliding part 8 (for example, the sliding part 8B, 8C, or 8D in FIG. 4).

Concave grooves 3e engaged with the protrusions 11q of the inner tube 11 in the rotational direction and annular concave portions 3f engaged with the convex portion 11r of the inner tube 11 in the axial direction are provided on the front side on the inner circumferential surface of the main body 3. The concave grooves 3e are formed in such a manner as to extend by a predetermined length backward from the front end of the main body 3 and disposed at positions equally divided by four in the circumferential direction on the inner circumferential surface of the main body 3. Also, the annular concave portions 3f extend in the circumferential direction between the concave grooves 3e.

The four sliding parts 8 are inserted into the main body 3 from the front side thereof, and the projection 8g of the sliding part 8 is brought into a state of being protruded to the outside from the notch portion 3a. Also, the inner tube 11 enters the front end of the main body 3. In this configuration, the protrusions 11q of the inner tube 11 enter the concave grooves 3e of the main body 3, and the convex portion 11r of the inner tube 11 enters the annular concave portions 3f of the main body 3, whereby the inner tube 11 is synchronously rotatably engaged with the main body 3.

As illustrated in FIGS. 3 and 4, the spring 9 is wound around the outer diameter of the rod portion 6c of the holding member 6 with a clearance left therebetween. One end (front end) of the spring 9 is abutted with the rear wall of the holding member storage portion 11s of the inner tube 11, and the other end (rear end) of the spring 9 is abutted with the flat surface 8e positioned at the front end of the sliding part 8. The sliding part 8 is brought into a state of being energized backward by means of the spring 9.

Hereinafter, the operation of the multi pencil 100 constituted in the above-mentioned manner during use will be described. Regarding the multi pencil 100 in an initial state illustrated in FIG. 3, the four sliding parts 8 are brought into a state of being positioned at the rear end of the notch portions 3a of the main body 3, and the four pipe members 1 are positioned on the inner side of the leading tube 2. In this state, when the sliding part 8A is moved forward by a predetermined distance along the notch portion 3a, as illustrated in FIG. 4, the holding member 6A, the screw tube 4A, the pipe member 1A, and the drawing material M1, which are engaged with the sliding part 8A in the axial direction, are moved forward, and the drawing material M1 is exposed forward from the opening portion 2a of the leading tube 2.

In this time, the front-side portion of the pipe member 1A enters the inner circumferential surface 2d of the leading tube 2, whereby the holding member 6A is bent in such a manner as to incline with respect to the axial direction, and the concave groove 1a of the pipe member 1 is engaged with the protrusions 2e of the leading tube 2 in the rotational direction. Then, the rear end portion 8h of the sliding part 8A is brought into a state of being hooked on the front end of the projections 3c of the main body 3.

In this state, for example, when a user relatively rotates the main body 3 in one direction (for example, clockwise) with respect to the leading tube 2, the inner tube 11, the four sliding parts 8, the four holding members 6, the four movable bodies 5 start rotating in the one direction. Herein, the pipe members 1B to 1D in which the concave grooves 1a are not engaged with the protrusions 2e of the leading tube 2, and the screw tubes 4B to 4D are rotated in the one direction in response to the relative rotation.

In contrast, the holding member 6A coupled with the pipe member 1A, in which the concave grooves 1a are engaged with the protrusions 2e of the leading tube 2, via the screw tube 4A, is bent in the one direction in response to the relative rotation and starts rotating in the one direction while being elastically deformed. Also, the pipe member 1A, in which the concave grooves 1a are engaged with the protrusions 2e of the leading tube 2, and the screw tube 4A do not rotate in the one direction in accordance with the rotation of the movable body 5A, and the movable body 5A relatively rotates with respect to the pipe member 1A and the screw tube 4A. Accordingly, the action of screw-threaded engagement between the male screw 5a of the movable body 5 and the female screw 4a of the screw tube 4 is exerted in response to the relative rotation in the one direction, and the movable body 5A starts advancing with respect to the pipe member 1A and the screw tube 4A. Then, the bottom surface 5d of the extruding portion 5c of the movable body 5A presses forward the drawing material M1 loaded in the pipe member 1A, whereby the movable body 5A and the drawing material M1 start advancing with respect to the pipe member 1A together.

Also, as illustrated in FIG. 9, during the relative rotation in the one direction, the protruding portions 11e of the inner tube 11 constituting the ratchet mechanism 12 are engaged with the concave and convex portion 2f of the leading tube 2 in the rotational direction, and the protruding portions 11e are energized in the radial direction by the elastic force of the notches 11f, so that engagement and release of engagement (mesh and release of mesh) between the protruding portions 11e and the concave and convex 2f are repeated. That is, when the relative rotation in the one direction is performed in a state where the protruding portions 11e and the concave and convex 2f are engaged in the rotational direction, the inclined surfaces 11e1 of the protruding portions 11e are abutted with the inclined surfaces 2f1 of the concave and convex portion 2f, and in this state, the inclined surfaces 11e1 are slid in such a manner as to climb up the inclined surfaces 2f1.

Then, after the protruding portions 11e climb over the convex portion of the concave and convex portion 2f, the protruding portions 11e and the concave and convex portion 2f are engaged in the rotational direction again. As a result, every time the protruding portions 11e and the concave and convex portion 2f are engaged and released, a sense of clicking is provided for a user. Note that, 24 projections and depressions are disposed side by side in the circumferential direction in the concave and convex portion 2f, so that a sense of clicking is provided for the user for every relative rotation of 15 degrees in one direction.

On the other hand, when the user tries to relatively rotate the main body 3 with respect to the leading tube 2 in the other direction (for example, counterclockwise), which is the direction opposite to the above-mentioned one direction, the lateral surfaces 11e2 of the protruding portions 11e constituting the ratchet mechanism 12 are abutted with lateral surfaces 2f2 of the concave and convex portion 2f, and the relative rotation in the other direction is regulated. Accordingly, the leading tube 2 and the main body 3 are not relatively rotated in the other direction. That is, the turning force (torque) of the relative rotation in the one direction is set to a force that can be easily rotated by the user, and the turning force of the relative rotation in the other direction is set to a force that cannot be easily rotated by the user. For example, when the outer diameter of the main body 3 is designed to correspond to approximately 14 mm, it is preferable that the torque of the relative rotation in the one direction be set to 0.1 N·m (newton meter) or lower, and the torque of the relative rotation in the other direction be set to 0.2 N·m or higher.

Also, as illustrated in FIG. 4, in a state where the pipe member 1A is moved forward by means of the forward movement of the sliding part 8A, and the drawing material M1 is exposed forward, when any of the sliding parts 8B to 8D (hereinafter referred to as another sliding part 8) is moved forward by a constant distance, the projection 8f of another sliding part 8, which is closely disposed on the inclined surface 8j of the sliding part 8A, is abutted with the inclined surface 8j. When the projection 8f of another sliding part 8 is abutted with the inclined surface 8j of the sliding part 8A, the sliding part 8A is pushed out to the outer side of the main body 3, and connection between the rear end portion 8h of the sliding part 8A and the front end of the projections 3c is released. Accordingly, the sliding part 8A is returned to the position of the rear end of the notch portion 3a by the backward energizing force of the spring 9A.

As described above, regarding the multi pencil 100, the drawing materials M are each coupled with the four sliding parts 8, and one arbitrary sliding part 8A moves forward by a constant distance with respect to the main body 3, whereby the drawing material M1 coupled with the sliding part 8A is exposed from the leading tube 2. Then, in this state, the leading tube 2 and the main body 3 are relatively rotated in one direction, whereby the drawing material M1 is configured to move forward, and furthermore, the drawing material M1 is regulated only in such a manner as to move forward.

Thus, it is configured that it only needs to consider the thrust of the drawing material M to the front side by means of the relative rotation in the one direction. Accordingly, this eliminates the constitution in which the drawing material M is moved backward while being held, so that the drawing material M, which is made of soft materials that are difficult to hold, can be applied to the multi pencil 100. Also, regarding the multi pencil 100, the drawing material M is not moved backward with respect to the pipe member 1, so that there is no problem in that the drawing material M needs to be additionally moved forward in the next round of use. Consequently, the usability can be improved.

In the multi pencil 100 of the present embodiment, the ratchet mechanism 12 that allows only the relative rotation of the leading tube 2 and the main body 3 in one direction is provided. Also, the multi pencil 100 includes the inner tube 11 positioned on the front side of the main body 3, and the ratchet mechanism 12 is constituted by the protruding portions 11e that protrude from the outer surface of the inner tube 11 and have elasticity in the radial direction, and the concave and convex portion 2f that are provided on the inner surface of the leading tube 2 and rotatably engaged with the protruding portions 11e. Thus, the protruding portions 11e that protrude from the outer surface of the inner tube 11 and the concave and convex portion 2f that are provided on the inner surface of the leading tube 2 can be utilized as the ratchet mechanism 12.

Also, the protruding portions 11e of the inner tube 11 are normally closely disposed with the concave and convex portion 2f of the leading tube 2, so that resistance can be generated at all times between the outer surface of the inner tube 11 and the inner surface of the leading tube 2, and unsteadiness between the inner tube 11 and the leading tube 2 can be restrained.

Also, the male screws 5a formed on the outer circumference of the movable body 5 have infinitesimal pitches, so that the shifting amount of the movable body 5 by means of the relative rotation in one direction is also infinitesimal. Accordingly, the fine adjustment of the drawing material M that is thrust forward can be made, thereby preventing the malfunction that the drawing material M, which is erroneously thrust out to a large extent, is snapped, so that the usability can further be improved.

Also, the front end of the movable body 5 is formed in a cylindrical shape having the flat bottom surface 5d, and the bottom surface 5d thrusts the drawing material M from the rear, which allows the drawing material M to move forward. Accordingly, this eliminates the structure as seen in the core chuck that holds the drawing material M, so that the drawing material M is configured to be thrust out by the bottom surface 5d of the front end of the cylindrical movable body 5.

Also, the holding member 6 includes the hole part 6a formed in a non-circular shape in accordance with the cross-sectional shape of the movable body 5, and the movable body 5, whose cross section is formed in a non-circular shape, is inserted into the hole part 6a formed in a non-circular shape. Accordingly, this allows the engagement of the movable body 5 with the holding member 6 in the rotational direction, so that the holding member 6 can function as a rotational stop for the movable body 5.

Also, the holding member 6 includes the O-ring 7 that provides the movable body 5 inserted in the hole part 6a with an elastic force from the outer side. Accordingly, the movable body 5 in the hole part 6a can be held by the elastic force of the O-ring 7 from the outer side, so that the movable body 5 can be mounted on the holding member 6 by the application of the elastic force, and the movable body 5 can be detached from the holding member 6 by appropriately setting the elastic force. Consequently, the movable body 5 (cartridge 10) can be mounted on and detached from the holding member 6 in an easy manner.

The embodiment of the present invention has been described above, but the present invention is not limited to the above-mentioned embodiment. The present invention can be modified within the scope of the gist described in Claims, and another form may be applied. That is, the constitution and shape of each component constituting the multi pencil 100 may be appropriately changed or modified within the scope in which the gist is not changed.

For example, in the present embodiment, the relative rotation of the leading tube 2 and the main body 3 in the other direction is regulated by the ratchet mechanism 12. However, another form may be applied, wherein the arrangement or shape of the protruding portions or the concave and convex portion constituting the ratchet mechanism is appropriately changed. Also, for example, in place of the ratchet mechanism 12, it is possible to adopt a mechanism in which the action of the threaded engagement of screw portions is utilized, a mechanism in which a frictional force is utilized, or a mechanism in which an elastic force is utilized. Furthermore, a constitution may be applied wherein the drawing material M is fed by the relative rotation in one direction, and the relative rotation in the other direction is not fed by means of a clutch mechanism (running idle) that releases the action of the threaded engagement. In short, only the forward movement of the drawing material M needs to be regulated by the relative rotation of the leading tube 2 and the main body 3 in one direction.

Also, in the present embodiment, the O-ring 7 that tightens the movable body 5 inward is provided, but the O-ring 7 may be omitted. For example, in place of the O-ring 7, the movable body 5 may be tightened inward by the elastic force of resin in the movable body holding portion.

Also, in the present embodiment, the holding member 6 includes the annular movable body holding portion 6b positioned on the front side thereof and the rod portion 6c positioned on the rear side thereof. However, the movable body holding portion and the rod portion may be separately formed. Then, for example, a fitting structure in which the movable body holding portion and the rod portion are synchronously rotatably fitted with each other may be provided.

Also, in the present embodiment, the pipe member 1 and the screw tube 4 are separately provided, but the pipe member and the screw tube may be integrally provided. Furthermore, the holding member 6 and the sliding part 8 are separately provided. However, for example, the rod portion 6c of the holding member 6 and the sliding part 8 can be integrated.

Also, in the present embodiment, the multi pencil 100 that includes the drawing materials M1 to M4 each having a different color has been described. However, the multi pencil may include drawing materials each having a different thickness, or furthermore, the multi pencil may include drawing materials each made up of a different material. Also, the number of drawing materials is not limited to four, but two, three, or five or more drawing materials may be provided. In short, the present invention can be applied as long as the multi pencil includes a plurality of drawing materials.

What is claimed is:

1. A multi pencil comprising:
a cylindrical main body;
a cylindrical leading tube configured to be engaged with the main body; and
a plurality of sliding parts configured to be each coupled with a plurality of drawing materials held in an interior of the leading tube and configured to be slidably provided by a constant distance with respect to the main body, and
wherein one arbitrary sliding part, out of the plurality of sliding parts, moves forward by a constant distance with respect to the main body, whereby the drawing material coupled with the one arbitrary sliding part is exposed from the leading tube, and in this state, the leading tube and the main body are relatively rotated in one direction, which allows the drawing material to move forward,
wherein only a forward movement of the drawing material is regulated by relative rotation of the leading tube and the main body in the one direction.

2. The multi pencil according to claim 1 further comprising a ratchet mechanism configured to allow a first relative rotation of the leading tube and the main body in the one direction and regulate a second relative rotation of the leading tube and the main body in other direction, which is opposite to the one direction.

3. The multi pencil according to claim 2 further comprising an inner tube configured to be positioned at a front portion of the main body, wherein the ratchet mechanism includes protruding portion that protrudes from an outer surface of the inner tube and have elasticity in a radial direction, and concave and convex portion that is provided on an inner surface of the leading tube and rotatably engaged with the protruding portions.

4. The multi pencil according to claim 3, wherein the protruding portions of the inner tube are abutted with the concave and convex portion of the leading tube at all times.

5. The multi pencil according to claim 1 further comprising a pipe member configured to be positioned in an interior of the leading tube, the pipe member in which the drawing material is loaded;
a movable body configured to extend in an axial direction on a rear portion of the drawing material and configured to include a male screw having infinitesimal pitches on an outer circumference; and
a screw tube configured to be synchronously rotatably engaged with a rear side of the pipe member and configured to include a female screw that is threadedly engaged with the male screw on an inner circumference,
wherein the sliding part moves forward by a constant distance with respect to the main body, which allows the pipe member to move forward and engage the leading tube in a rotational direction, and wherein, in this state, the leading tube and the main body are relatively rotated in the one direction, whereby the movable body moves forward with the drawing material by action of a screw-threaded engagement between the male screw and the female screw.

6. The multi pencil according to claim 2 further comprising a pipe member configured to be positioned in an interior of the leading tube, the pipe member in which the drawing material is loaded;
a movable body configured to extend in an axial direction on a rear portion of the drawing material and configured to include a male screw having infinitesimal pitches on an outer circumference; and
a screw tube configured to be synchronously rotatably engaged with a rear side of the pipe member and configured to include a female screw that is threadedly engaged with the male screw on an inner circumference,
wherein the sliding part moves forward by a constant distance with respect to the main body, which allows the pipe member to move forward and engage the leading tube in a rotational direction, and wherein, in this state, the leading tube and the main body are relatively rotated in the one direction, whereby the movable body moves forward with the drawing material by action of a screw-threaded engagement between the male screw and the female screw.

7. The multi pencil according to claim 3 further comprising a pipe member configured to be positioned in an interior of the leading tube, the pipe member in which the drawing material is loaded;
a movable body configured to extend in an axial direction on a rear portion of the drawing material and configured to include a male screw having infinitesimal pitches on an outer circumference; and
a screw tube configured to be synchronously rotatably engaged with a rear side of the pipe member and configured to include a female screw that is threadedly engaged with the male screw on an inner circumference,
wherein the sliding part moves forward by a constant distance with respect to the main body, which allows the pipe member to move forward and engage the leading tube in a rotational direction, and wherein, in this state, the leading tube and the main body are relatively rotated in the one direction, whereby the movable body moves forward with the drawing material by action of a screw-threaded engagement between the male screw and the female screw.

8. The multi pencil according to claim 4 further comprising a pipe member configured to be positioned in an interior of the leading tube, the pipe member in which the drawing material is loaded;
a movable body configured to extend in an axial direction on a rear portion of the drawing material and configured to include a male screw having infinitesimal pitches on an outer circumference; and
a screw tube configured to be synchronously rotatably engaged with a rear side of the pipe member and configured to include a female screw that is threadedly engaged with the male screw on an inner circumference,
wherein the sliding part moves forward by a constant distance with respect to the main body, which allows the pipe member to move forward and engage the leading tube in a rotational direction, and wherein, in this state, the leading tube and the main body are relatively rotated in the one direction, whereby the movable body moves forward with the drawing material by action of a screw-threaded engagement between the male screw and the female screw.

9. The multi pencil according to claim 5, wherein a front end of the movable body is formed in a cylindrical shape having a flat bottom surface, and wherein the bottom surface thrusts the drawing material forward, which allows the drawing material to move forward.

10. The multi pencil according to claim 6, wherein a front end of the movable body is formed in a cylindrical shape having a flat bottom surface, and wherein the bottom surface thrusts the drawing material forward, which allows the drawing material to move forward.

11. The multi pencil according to claim 7, wherein a front end of the movable body is formed in a cylindrical shape having a flat bottom surface, and wherein the bottom surface thrusts the drawing material forward, which allows the drawing material to move forward.

12. The multi pencil according to claim 8, wherein a front end of the movable body is formed in a cylindrical shape having a flat bottom surface, and wherein the bottom surface thrusts the drawing material forward, which allows the drawing material to move forward.

13. The multi pencil according to claim 5 further comprising a holding member configured to be arranged on a rear portion of the screw tube and hold the movable body inside,
wherein a cross section of the movable body is formed in a non-circular shape, and wherein the holding member includes a hole part formed in a non-circular shape in accordance with a cross-sectional shape of the movable body.

14. The multi pencil according to claim 6 further comprising a holding member configured to be arranged on a rear portion of the screw tube and hold the movable body inside,
wherein a cross section of the movable body is formed in a non-circular shape, and wherein the holding member includes a hole part formed in a non-circular shape in accordance with a cross-sectional shape of the movable body.

15. The multi pencil according to claim 7 further comprising a holding member configured to be arranged on a rear portion of the screw tube and hold the movable body inside,
wherein a cross section of the movable body is formed in a non-circular shape, and wherein the holding member includes a hole part formed in a non-circular shape in accordance with a cross-sectional shape of the movable body.

16. The multi pencil according to claim 8 further comprising a holding member configured to be arranged on a rear portion of the screw tube and hold the movable body inside,
wherein a cross section of the movable body is formed in a non-circular shape, and wherein the holding member includes a hole part formed in a non-circular shape in accordance with a cross-sectional shape of the movable body.

17. The multi pencil according to claim 9 further comprising a holding member configured to be arranged on a rear portion of the screw tube and hold the movable body inside,
wherein a cross section of the movable body is formed in a non-circular shape, and wherein the holding member includes a hole part formed in a non-circular shape in accordance with a cross-sectional shape of the movable body.

18. The multi pencil according to claim 10 further comprising a holding member configured to be arranged on a rear portion of the screw tube and hold the movable body inside,
wherein a cross section of the movable body is formed in a non-circular shape, and wherein the holding member includes a hole part formed in a non-circular shape in accordance with a cross-sectional shape of the movable body.

19. The multi pencil according to claim 11 further comprising a holding member configured to be arranged on a rear portion of the screw tube and hold the movable body inside,
wherein a cross section of the movable body is formed in a non-circular shape, and wherein the holding member includes a hole part formed in a non-circular shape in accordance with a cross-sectional shape of the movable body.

20. The multi pencil according to claim 12 further comprising a holding member configured to be arranged on a rear portion of the screw tube and hold the movable body inside,
wherein a cross section of the movable body is formed in a non-circular shape, and wherein the holding member includes a hole part formed in a non-circular shape in accordance with a cross-sectional shape of the movable body.

21. The multi pencil according to claim 13, wherein the holding member includes an elastic portion configured to provide the movable body inserted in the hole part with an elastic force from an outer side.

22. The multi pencil according to claim 14, wherein the holding member includes an elastic portion configured to provide the movable body inserted in the hole part with an elastic force from an outer side.

23. The multi pencil according to claim 15, wherein the holding member includes an elastic portion configured to provide the movable body inserted in the hole part with an elastic force from an outer side.

24. The multi pencil according to claim 16, wherein the holding member includes an elastic portion configured to provide the movable body inserted in the hole part with an elastic force from an outer side.

25. The multi pencil according to claim 17, wherein the holding member includes an elastic portion configured to provide the movable body inserted in the hole part with an elastic force from an outer side.

26. The multi pencil according to claim 18, wherein the holding member includes an elastic portion configured to provide the movable body inserted in the hole part with an elastic force from an outer side.

27. The multi pencil according to claim 19, wherein the holding member includes an elastic portion configured to provide the movable body inserted in the hole part with an elastic force from an outer side.

28. The multi pencil according to claim 20, wherein the holding member includes an elastic portion configured to provide the movable body inserted in the hole part with an elastic force from an outer side.
